(19) United States
(12) Patent Application Publication
(10) Pub. No.: US 2008/0239307 A1
(43) Pub. Date: Oct. 2, 2008

(54) Sequencing single molecules using surface-enhanced Raman scattering

(75) Inventors: Chad E. Talley, Tustin, CA (US); Thomas R. Huser, El Grove, CA (US); Christopher W. Hollars, Overland Park, KS (US); Stephen M. Lane, Oakland, CA (US)

Correspondence Address: Lawrence Livermore National Security, LLC, LAWRENCE LIVERMORE NATIONAL LABORATORY, PO BOX 808, L-703, LIVERMORE, CA, 94551-0808, US

(73) Assignee: The Regents of the University of California

(21) Appl. No.: 11/731,418

(22) Filed: Mar. 30, 2007

(51) Int. Cl. G01J 3/44

(52) U.S. Cl. 356/301

(57) ABSTRACT

A surface-enhanced Raman scattering method and apparatus to sequence polymeric biomolecules such as DNA, RNA, or proteins is introduced. The method uses metallic nanostructures such as, for example, spherical or cylindrical Au or Ag nanoparticles having characteristic lengths of 10-100 nm which when illuminated with light of the appropriate wavelength produce resonant oscillations of the conduction electrons (plasmon resonance). Electric field enhancements of 30-1000 near the particle surface resulting from such oscillations increase Raman scattering cross-sections by about 10⁶-10¹⁵ due to the E⁴ dependence of the Raman scattering, wherein the largest enhancements occur in the gap/junction between novel closely spaced structures as disclosed herein.

The United States Government has rights in this invention pursuant to Contract No. W-7405-ENG-48 between the United States Department of Energy and the University of California for the operation of Lawrence Livermore National Laboratory.

### BACKGROUND OF THE INVENTION

1. Field of the Invention

The present invention relates in general to molecular sensors and methods of identification, and more particularly to a detection of a single molecule (i.e., a polymeric biomolecule) by Raman based methods, such as, surface enhanced Coherent anti-Stokes Raman spectroscopy (SECARS), surface-enhanced resonance Raman scattering (SERRS), but more often surface-enhanced Raman scattering (SERS) for sequencing such single molecules by using the methods and apparatus disclosed herein.

2. Description of Related Art

Raman scattering is the inelastic scattering of optical photons by interaction with vibrational modes of molecules. Typically, Raman scattered photons have energies that are slightly lower (i.e., Stokes-shifted photons) than the incident photons with the energy differences related to molecular vibrational energy levels. The energy spectrum of scattered photons commonly comprise narrow peaks and provides a unique spectral signature of the scattering molecule, allowing a molecule to be identified without the need for optical labels or prior knowledge of the chemicals present in the sample. Additionally, the vibrational spectra acquired in Raman spectroscopy are complementary to the vibrational spectra acquired by infrared (IR) absorption spectroscopy, providing an additional database for peak assignment and molecular identification.

A drawback of Raman spectroscopy, however, is that the typical molecular cross-sections for Raman scattering are extremely low, on the order of 10⁻²⁹ cm⁻². These low cross-sections often require high laser fluences and long signal integration times to produce spectra with sufficient signal-to-noise. While Raman spectroscopy has been used as an analytical tool for certain applications due to its excellent specificity for chemical group identification, its low sensitivity historically has limited its applications to highly concentrated samples. Background for such a method is described by Lewis, I. R. and H. G. M. Edwards in Handbook of Raman Spectroscopy, Practical Spectroscopy, ed., Vol. 28. 2001, Marcel Dekker, Inc.: New York, 1054.

Surface-enhanced Raman scattering (SERS) provides an enhancement in the Raman scattering signal by up to 10⁶ to 10¹⁰ for molecules adsorbed on microstructures of metal surfaces. Background for this concept is described in Surface-Enhanced Spectroscopy, by Moskovits, M., Rev. Mod. Phys., 57(3): p. 783-828 (1985). The enhancement is due to a microstructured metal surface scattering process which increases the intrinsically weak normal Raman Scattering due to a combination of several electromagnetic and chemical effects between the molecule adsorbed on the metal surface and the metal surface itself.

The enhancement is primarily due to enhancement of the local electromagnetic field in the proximity of the molecule resulting from plasmon excitation at the metal surface. [Moskovits, M., Surface-Enhanced Spectroscopy, Rev. Mod. Phys., 1985. 57(3): p. 783-828; Kneipp, K., et al., Ultrasensitive Chemical Analysis by Raman Spectroscopy, Chem. Rev., 1999. 99: p. 2957-2975]. Although chemisorption is not essential, when it does occur there may be further enhancement of the Raman signal, since the formation of new chemical bonds and the consequent perturbation of adsorbate electronic energy levels can lead to a surface-induced resonance effect. [Moskovits, M., Surface-Enhanced Spectroscopy, Rev. Mod. Phys., 1985. 57(3): p. 783-828; Kneipp, K., et al., Ultrasensitive Chemical Analysis by Raman Spectroscopy, Chem. Rev., 1999. 99: p. 2957-2975]. The combination of surface- and resonance-enhancement (SERS) can occur when adsorbates have intense electronic absorption bands in the same spectral region as the metal surface plasmon resonance, yielding an overall enhancement as large as 10¹⁰ to 10¹². Kneipp, K., et al., Ultrasensitive Chemical Analysis by Raman Spectroscopy, Chem. Rev., 1999. 99: p. 2957-2975.

In addition to roughened metal surfaces, solid gold and silver nano-particles in a size range of approximately 40 nm to about 200 nm can also generate SERS. These particles support resonant surface plasmons that can be excited by electromagnetic radiation, wherein the absorption maximum for such particles depends on a number of factors, such as material (e.g., gold, silver, copper), size, shape and the dielectric constant of the medium surrounding the particle. [Yguerabide, J. and E. E. Yguerabide, Light-Scattering Submicroscopic Particles as Highly Fluorescent Analogs and Their Use as Tracer Labels in Clinical and Biological Applications, II. Experimental Characterization. Anal. Biochem., 1998. 262: p. 157-176; Yguerabide, J. and E. E. Yguerabide, Light-Scattering Submicroscopic Particles as Highly Fluorescent Analogs and Their Use as Tracer Labels in Clinical and Biological Applications, I. Theory. Anal. Biochem., 1998. 262: p. 137-156]. These properties make the particles useful as substrates for surface-enhanced Raman spectroscopy, which can increase the Raman-scattered signal by many orders-of-magnitude above that of conventional SERS approaches involving planar, roughened surfaces. Kneipp, K., et al., Ultrasensitive Chemical Analysis by Raman Spectroscopy, Chem. Rev., 1999. 99: p. 2957-2975.

Background information for systems and methods based on Raman and surface-enhanced Raman scattering (SERS) is described and claimed in U.S. Patent No. 2003/0059820 A1, entitled “SERS Diagnostic Platforms, Methods and Systems Microarrays, Biosensors and Biochips,” issued Mar. 27, 2003 to Vo-Dinh, including the following, “In a preferred embodiment of the invention, the sampling platform is a SERS platform, permitting the system to be a SERS sensor. The SERS sampling platform includes one or more structured metal surfaces. A plurality of receptor probes are disposed anywhere within the range of the enhanced local field emanating from the structured metal surfaces. The Raman enhancement occurs upon irradiation of the structured metal surfaces. Such receptor probe proximity permits SERS enhancement of the Raman signal from the receptor probe/target combination which is formed following a binding event . . . .”

The present invention utilizes various novel arrangements that harness Raman scattering to provide the sequencing of long chains of nucleic acids. Conventionally, such sequencing depends on the detection of fluorescently labeled nucleic acids that are configured in “oligomers” (e.g., lengths of molecules having about 500 to 1,000 bases of nucleic acid sequences) of the functional unit of DNA or RNA (i.e., a gene sequence) to enable the reading of such molecules. Fluorescence labeling, in particular, has a number of short-comings, such as complicated chemistry, insufficient labeling efficiency, and photobleaching or quenching of the fluorophore. Furthermore, fluorescence labeling requires the relatively short “oligomers” of DNA to be stitched together offline by advanced computer programs in order to obtain the full sequence. Such a process is inefficient, time-consuming and cost ineffective. The present invention described herein eliminates these shortcomings by removing the need for extrinsic labels.

Accordingly, a need exists for an improved Raman based method and apparatus/system for sequencing single polymeric biomolecules. The present invention is directed to such a need.

### SUMMARY OF THE INVENTION

The present invention is directed to an apparatus that utilizes resonant pole nano-structures configured within a fluidic channel, such nano-structures and desired arranged polymeric biomolecules being optically coupled with a detection means for identifying nucleotides from the arranged polymeric biomolecules via one or more Raman-induced spectra.

Another aspect of the present invention is directed to one or more wedge shaped nano-structures configured within a fluidic channel, such nano-structures and adjacent one or more desired polymeric biomolecules being optically coupled with a detection means for identifying nucleotides from the arranged polymeric biomolecules via one or more Raman induced spectra.

Another aspect of the present invention is directed to a sequencing method that includes: directing one or more nucleic acid molecules therethrough a fluidic channel; sequentially probing the nucleotides along the one or more nucleic acid molecules by way of preconfigured resonant pole nano-structures;
and optically identifying the probed nucleotides by way of Raman induced spectra.

A final aspect of the present invention is directed to a sequencing method that includes: directing one or more polymeric biomolecules therethrough a fluidic channel; sequentially probing the nucleotides along said one or more polymeric biomolecules by way of one or more preconfigured wedged nano-structures; and optically identifying said probed nucleotides by way of Raman induced spectra.

Accordingly, the present invention provides a desired surface-enhanced Raman spectroscopy (e.g., SERS, SERRS, CARS, or SECARS) apparatus and method that is simpler in design, cheaper, and quicker than present methods to map or sequence single polymeric molecules. Such a system and method can be implemented in applications that include medicine, health care, biotechnology, environmental monitoring and national security.

### BRIEF DESCRIPTION OF THE DRAWINGS

FIG. 1a illustrates a beneficial example sequencing embodiment of the present invention having a preconfigured resonant structure adapted to read directed molecules.

FIG. 1b shows a sequencing embodiment using coupled beads immobilizing a molecule, wherein the coupled beads are held by optical traps.

FIG. 2a shows another beneficial example sequencing embodiment of the present invention, wherein one end of a molecule is immobilized with a bead and the nucleotides are removed by an exonuclease to be read by resonant nano-structure of the present invention.

FIG. 2b shows example nanoparticle resonant structures of the present invention.

FIG. 3 illustrates a wedge resonant structure of the present invention.

FIG. 4 illustrates an example detection apparatus for monitoring the Raman signal from individual nucleotides.

FIG. 5 shows example SERS spectra of four nucleic acids detected by the present invention.

### DETAILED DESCRIPTION OF THE INVENTION

Referring now to the following detailed information, and to incorporated materials; a detailed description of the invention, including specific embodiments, is presented.

Unless otherwise indicated, numbers expressing quantities of ingredients, constituents, reaction conditions and so forth used in the specification and claims are to be understood as being modified by the term “about.” Accordingly, unless indicated to the contrary, the numerical parameters set forth in the specification and attached claims are approximations that may vary depending upon the desired properties sought to be obtained by the subject matter presented herein. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the subject matter presented herein are approximations, the numerical values set forth in the specific examples are reported as precisely as possible. Any numerical value, however, inherently contains certain errors necessarily resulting from the standard deviation found in their respective testing measurements.

Moreover, in the description of the invention herein, it is understood that a word appearing in the singular encompasses its plural counterpart, and a word appearing in the plural encompasses its singular counterpart, unless implicitly or explicitly understood or stated otherwise. Furthermore, it is understood that for any given component or embodiment described herein, any of the possible candidates or alternatives listed for that component, may generally be used individually or in combination with one another, unless implicitly or explicitly understood or stated otherwise. Additionally, it will be understood that any list of such candidates or alternatives, is merely illustrative, not limiting, unless implicitly or explicitly understood or stated otherwise.

Finally, various terms used herein are described to facilitate an understanding of the invention. It is understood that a corresponding description of these various terms applies to corresponding linguistic or grammatical variations or forms of these various terms. It will also be understood that the invention is not limited to the terminology used herein, or the descriptions thereof, for the description of particular embodiments.

### General Description

The present invention provides an apparatus/system and method using configured resonant nanostructures for mapping, e.g., sequencing of polymeric biomolecules such as, but not limited to, synthetic nucleotide analogs or proteins but most often chromosomal, mitochondrial and chloroplast single-stranded, double-stranded, triple stranded or any chemical DNA modifications thereof and ribosomal, transfer, heterogeneous nuclear and messenger RNA, using any Raman technique capable of meeting the specifications of the present invention. The nanostructures themselves serve a number of purposes: 1) it is a resonant structure that produces a large electromagnetic field enhancement of up to about 1000, 2) such nanostructures serve to confine the high field within a region small enough to mainly obtain a signal from a single nucleotide, and 3) they physically confine the DNA molecule so that it remains within the high field region.

Coherent anti-Stokes Raman spectroscopy (CARS) and more often surface enhanced coherent anti-Stokes Raman spectroscopy (SECARS) are other such examples of Raman techniques that can be utilized in the present invention, wherein two phase matched beams differing in frequency by the molecular vibration of interest are focused onto the sample. In this way the vibrational mode is resonantly pumped, increasing the photon scattering rate from the selected vibrational mode to produce theoretical enhancements in concert with SERS of up to 10²¹.

A preferred embodiment of the present invention utilizes surface-enhanced Raman scattering (SERS), wherein metal surface plasmons are easily excited by an optical source, such as, but not limited to, one or more gas (e.g., a 633 nm He—Ne laser) or solid-state lasers, e.g., compact diode laser sources, etc., having either a continuous wave (CW) output or a pulsed output of up to about 80 MHz and configured with wavelengths of at least 200 nm, more often between about 200 nm and about 1100 nm, and capable of a peak energy of up to about 3×10⁻⁹ J. While a Ti:Sapphire or a Nd:YAG solid-state optical source can provide the necessary bandwidth and in some cases the high repetition-rate for the present invention, any lasing medium and/or pulse forming mechanism capable of producing the proper bandwidth and CW or pulsed output can also be employed. For example, other exemplary solid-state lasing media can include Neodymium(Nd)-doped glass, Neodymium-doped yttrium lithium fluoride, Yb:YAG, Yb:glass, KGW, KYW, YLF, S-FAP, YALO, YCOB, and GdCOB or other broad bandwidth solid state materials. Other exemplary CW lasing media can include diode lasers or gas lasers, such as, but not limited to, Argon, Helium Cadmium, Krypton lasers or doubled Krypton lasers, Excimers, etc.

Upon illumination from a chosen optical source and in some embodiments the source having a degree of polarization comprising: linear, elliptical, circular or random polarization, the induced electric fields cause other nearby molecules to become Raman active resulting in amplification of the Raman signal by up to about 10¹⁵. A variation of this technique as utilized herein can include surface enhanced resonance Raman scattering (SERRS), wherein an excitation wavelength is matched to an electronic transition of the molecule, so that vibrational modes associated with the excited electronic state are even further enhanced.

The method as well as the apparatus/system capitalizes on such Raman effects and novel predetermined metallic resonant structures arranged as, for example, wedges, monopoles, dipoles, quadrapoles, higher multi-poles, and/or a super-position of many multipole components (e.g., a plurality of dipole pairs), which when illuminated with light of the appropriate wavelength produce concentrated resonant oscillations of the conduction electrons (plasmon resonance). Such resonant structures, (e.g., resonant pole and wedge nanostructures) fabricated with currently available tools and often configured from metals, such as, but not necessarily limited to, Gold (Au), Copper (Cu), or Silver (Ag), can be arranged into various shapes, such as, spherical, rodlike, cubic, triangular, ellipsoidal, configured as a nanoshell, configured as a nanoshell with a magnetic interior (i.e., such a magnetic interior enables magnetic field positioning), etc., having characteristic lengths of about 10 nm up to about 50 nm. Electric field enhancements of 30-1000 (Kneipp et al., Chem. Rev., 99 2957 (1999)) near such surfaces resulting from the induced oscillations increase the Raman scattering cross-sections by, for example, about 10⁶ and up to about 10¹⁵ for SERS, as discussed above, due to the E⁴ dependence of the Raman scattering, wherein the largest enhancements occur in the gap/junction between closely spaced structures. These extremely large enhancements in the Raman scattering cross-section signal have made it possible to observe the Raman scatter from single molecules.

In addition, with respect to nanoshells, and more particularly, with respect to spherical nanoshells, the frequencies of the surface plasmons of a shell having a configured hole can be tuned by changing the internal radii (b) to external radii (a) ratio (i.e., b/a) of the shell. Thus, the shell is adjusted to match the frequency of a hole having a desired diameter, wherein the lower energy excitations are a symmetric combination of a hole plasmon mode with a shell plasmon mode. The result is that a shell with holes, as disclosed herein, can be at least 44 times more efficient than a perfect shell for SERS.

In a preferred embodiment of the present invention, DNA or RNA single nucleotides in the enhanced field produce Raman spectra that can be used to optically fingerprint a known or unknown nucleotide representing such molecules for sequencing purposes. Desired single stranded DNA (ssDNA) to be sequenced by the present invention may be prepared from double stranded DNA (dsDNA) by any of the standard methods known and understood by one of ordinary skill in the art. As a well known exemplary method, dsDNA may be heated above its annealing temperature so as to spontaneously separate dsDNA into ssDNA. In addition, ssDNA may be prepared from double-stranded DNA by standard amplification techniques known in the art, using a primer that only binds to one strand of double-stranded DNA.

Various methods for scanning the DNA or RNA oligonucleotide molecules are provided herein, wherein such molecules are designed to pass, e.g., flow past the resonant structures, i.e., the “read head” or are configured to be fixedly attached and held in place while being read by such resonant structures to measure the sequence.

In an exemplary arrangement, desired stretched molecules of greater than about 1,000 bases in length can be configured to pass through an orifice of about 0.1 nm up to about 5 nm while illuminated with predetermined wavelengths of at least 200 nm, more often between about 200 nm and about 1100 nm, with resonant structures of the present invention configured at the entrance or exit of such orifices in order to produce the largest fields in the gap. (Talley, et al., Anal. Chem., 76, 7064-7068 (2004), Brus, et al., J. Phys. Chem. B, 107, 9964 (2003)).

Other beneficial arrangements include scanning the read head (e.g., affixing a resonant structure to the tip of an atomic force microscope and moving the tip) or scanning the molecule past the read head, or affixing a resonant structure to a motor molecule (e.g., a polymerase) which carries the structure along the molecule to enable the mapping, i.e., sequence structure of a molecule to be determined.

Other methods include exonuclease enzymes that degrade the oligonucleotide breaking it into individual bases that are then sequentially identified using a SERS resonant structure as disclosed herein, by for example, the use of flow within predetermined microfluidic structures as known and understood by those of ordinary skill in the art.

### Specific Description

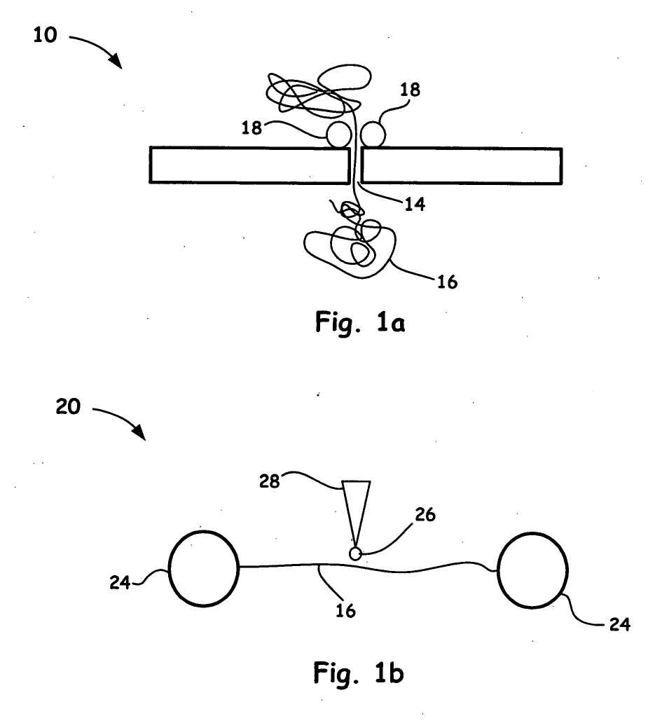

Turning now to the drawings, FIG. 1a shows a beneficial example sequencing embodiment, generally designated by reference numeral 10, having a designed opening 14, e.g., a small orifice or pore, often having a dimension between about 0.1 nm and about 5 nm, more often between about 2 nm and about 5 nm and a resonant structure 18 disposed within a directed flow environment (not shown). The arrangement of the opening 14 in the flow environment causes a predetermined portion of molecule 16, e.g., DNA, to temporarily form straight sections of DNA of about several thousand to about several million bases (note: the molecules can be of any length and can be processed by the present invention so long as the passage through the orifice is unrestricted and the molecule remains intact) so as to be directed through opening 14 and past the configured resonant structure 18 having, for example, two or more configured nanostructures of the present invention (shown in FIG. 1a as an example spherical dipole arraignment).

The flow environment can include microfluidic structures (not shown), such as, but not limited to, one or more photolithographic etched micron sized channels and subchannels (e.g., opening 14) on silica, silicon or other crystalline substrates or chips. The flow rates themselves can be controlled at greater than or equal to about 210 kilobases/second using known viscous media and flow techniques utilized in the field within the disposed configured microfluidic channels. Such a velocity can be further controlled, e.g., further slowed by using viscous media or other methods such as by manipulating magnetic beads attached to the end of one or more molecules 16. Another example method to thread DNA past SERS arrangements of the present invention can be found in: Microsecond time-scale discrimination among polycytidylic acid, polyadenylic acid, and polyuridylic acid as homopolymers or as segments within single RNA molecules, by Akeson M, Branton D, Kasianowicz J J, Brandin E, Deamer D W. Biophys J. 1999 December; 77(6):3227-33. Using such a method, a biological ion pore (e.g., opening 14) having for example, a 2.6 nm opening can be imbedded in a membrane substrate (not shown). The membrane and pore system are placed in an ionic solution. By providing a voltage difference between each end of the pore (i.e. a voltage difference across the membrane) an ion current through the pore can be generated. The flow of ions can cause a DNA molecule to thread itself spontaneously through opening 14.

In whatever arrangement chosen to direct the molecules of the present invention though opening 14 and necessarily past a desired resonant structure 18, such molecules are collaterally illuminated within the arrangement (i.e., as it passes through the resonant structure) with a predetermined wavelength from an optical source (not shown) (a CW or a pulsed optical source having an output wavelength of at least 200 nm, more often between about 200 nm and about 1100 nm). A characteristic fingerprint of the molecule (e.g., each of the bases that make up a DNA molecule) can then be produced by a desired Raman method, e.g., SERS. Thereafter, the resultant fingerprint facilitated by the excitation of plasmon modes produced on the surface of the nanoparticles, i.e., resonant structure 18, can be recorded with an appropriate detection system known and understood by those of ordinary skill in the art.

FIG. 1b shows an alternative example embodiment of the present invention, generally designated by reference numeral 20, wherein a molecule 16, such as, a DNA molecule often having between about 20 to about 100 bases, but equally capable of greater than about 1000 bases, is pulled substantially straight by a pair of predetermined beads 24, such as, for example, dielectric or magnetic beads attached to either end of a predetermined molecule 16 or an oligomer of such a molecule 16. The attachment of the molecule 16, such as DNA or RNA, can be enabled using a variety of methods understood and used by those of ordinary skill in the art. For example a predetermined nucleic acid molecule to be sequenced can be attached to a bead of the present invention using non-covalent or covalent attachment between the nucleic acid molecule and the surface of a desired bead, e.g., beads 24, as shown in FIG. 1b, by coating, in one example, the dielectric material used for the beads with crosslinking reagents known and used by those of ordinary skill in the art. As a specific example to illustrate such a method but not limiting to the present invention, DNA can be bound to glass by first silanizing the glass surface, then activating with carbodimide or glutaraldehyde.

In other example arrangements, the coupled surface, such as bead-like surface structures, may be magnetic beads, non-magnetic beads, but such a surface need not be bead-like but can be any surface, a nylon, quartz, glass, or a polymer surface, capable of coupling to a desired molecule 16 of the present invention and thus capable of stretching and immobilizing the desired molecule 16 using methods known in the art so as to be sequenced using the methods and techniques herein.

In a beneficial embodiment, beads 24 of the present invention, i.e., dielectric beads, are held in place using dual-optical traps. The traps comprise optical radiation, such as, optical radiation from a laser source, which is focused to create a predetermined intense region of light to produce radiation pressure. This induced radiation pressure creates small forces by absorption, reflection, or refraction of light by a material, such as dielectric beads 24 of material utilized herein, to trap the beads 24 and position the beads 24 in the trap with precise control and with a low spring constant. Such methods are known and understood by those of ordinary skill in the art (see for illustrations purposes, U.S. Pat. No. 5,512,745 A1, entitled, “Optical Trap Method and System,” to Finer et al).

Upon trapping of the beads 24 and arranging the beads to produce a resultant stretched molecule(s) 16, as illustrated in FIG. 1b, molecule 16 is probed by a directed Raman (e.g., SERS) resonant structure 26, such as, a Au, Cu, or Ag curved structures arranged as, but not limited to, nanorod, nanoellipsoid, nanoshell, nanopyramid, but often a substantially spherical resonant nanoparticle structures, that are capable of being coupled to a movement means, such as an atomic force microscope tip 28. From such an example arrangement, the tip 28 can be manipulated using, for example, the accompanying apparatus (i.e., an atomic force known by those of ordinary skill in the art) to scan the length of a stretched nucleotide, such as a predetermined length of a DNA molecule 16 strand.

Alternatively, the various disclosed immobilizing surfaces, e.g., dielectric or magnetic beads 24, can be maneuvered optically, magnetically, or mechanically (e.g., using translation stages configured with the environment), so as to scan a desired molecule 16 along a fixed resonant structure 26.

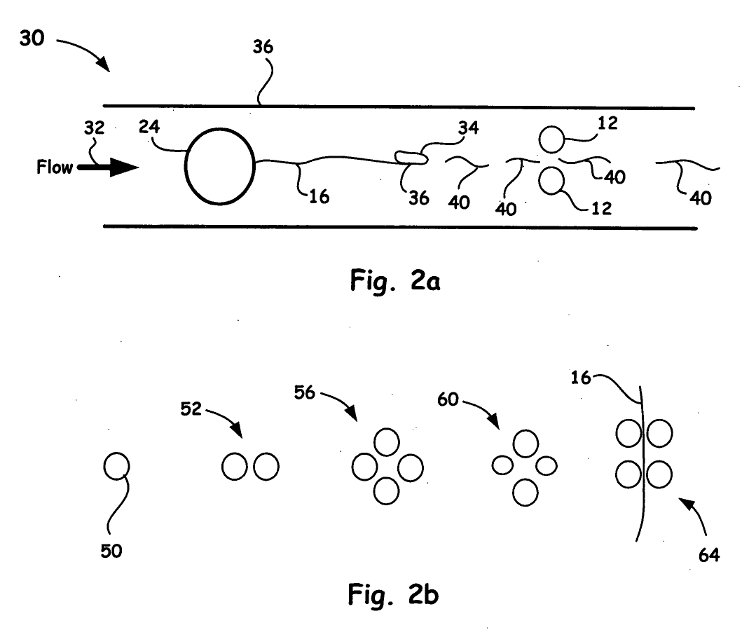

FIG. 2a shows another example embodiment of the present invention and generally designated by the reference numeral 30, wherein a molecule strand 16, such as a strand of DNA, is held in a fluidic flow field 32 (also denoted with an accompanying directional arrow) using a laser trapped bead 24 at one end. The arrangement includes a bound reagent 34 to a free end 36 of molecule strand 16 and often includes an enzyme catalyst, such as an exonuclease. The bound reagent 34 in conjunction with an exonuclease operate to degrade one at a time, for example, an oligonucleotide molecule into sectioned portions, which allows the sequential identification of each nucleotide 40 using methods as disclosed herein, after passing through the SERS resonant structures 12 of the present invention.

Similar to the description above for the embodiment of FIG. 1a, microfluidic structures that incorporate the flow 32 of a solvent within a disposed configured channel, such as, but not limited to, a photolithographic etched micron sized channel on silica, silicon or other crystalline substrates or chips, can also be adapted with the configuration of FIG. 2a to facilitate the movement of a sectioned nucleotide 40 in preserving the sequential order of the nucleotides.

Accordingly, by adjusting the rate of exonuclease activity (e.g., varying temperature, pH, etc.) as well as the flow rate within such channels enables such individual nucleotides to be sequentially preserved and optimally analyzed using the present system and methods herein.

As an alternative, microcapillary electrophoresis methods and structures known by those of ordinary skill in the art can also be integrated into the present invention to adjust the movement rate while manipulating the exonuclease activity so as to coincide with the optimal analysis rate and necessary order of the individual nucleotides. Using such known methods, a sectioned nucleotide 40, such as, a sectioned DNA nucleotide having particular size ranges, can be transported down a predetermined thin capillary or channel 36 often having a separation medium (not shown), through channel 36, and accordingly past resonant structure 12 so as to enable the detection and thus the sequencing of desired molecule 16 using the Raman methods disclosed herein.

FIG. 2b illustrates example nanoparticle resonant structures of the present invention. Reference numeral 50 depicts a monopole resonant structure, reference numeral 52 illustrates a dipole resonant structure while reference numeral 56 includes a configured quadrapole arrangement. It is to be appreciated that while such above resonant structure arrangements are beneficial, other example resonant arrangements having even higher multipole (not shown) capabilities can also be implemented to produce desired results that are beneficial for accumulation of additional molecular information. As an example not meant to be limiting, such higher multiple dipole pairs simultaneously can be excited by the appropriate illumination wavelength(s) having, for example, an appropriate mixture of polarizations so as to obtain additional or redundant spectral information. In addition, dipoles of different sizes 60 or in various combinations with other pole arrangements (e.g., a superposition of many multipole components) and illuminated by different wavelengths can also be used to obtain additional spectral information. For example, serial stacks 64 of resonant structures can be used to obtain additional information, such as, more accurate spectral deconvolution about the individual probed molecules 16.

Additional structures can serve to better focus the electric field or produce redundant determinations of the sequence. Furthermore, resonant structures that are constructed from nanorods, nanoellipsoids, nanoshells, wedges, nanopyramids, and other structures results in gaps between such differing shapes that can produce even higher field enhancements for enhancing spectral component signals from a given nucleotide.

It is to be noted that the nucleotide closest to the resonant structure, in the case of a DNA molecule for example, produces the strongest spectral component and that a measured spectrum from such a molecule as detected and recorded by the apparatus/system/methods of the present invention often result from, but not necessarily to, a superposition of signals from many nucleotides. Mathematical methods can then be used to decompose the contributions from such detected nucleotides, thus allowing determination of the sequence to address spatial resolution detection of a single nucleotide. Redundant serial measurements can also be helpful in resolving the sequence.

Another novel configuration of the present invention uses a molecular motor (such as a polymerase enzyme) functionalized with a resonant structure that is capable of using biochemical energy to scan the structure along the DNA. For example, a single gold nanoparticle can be bound to such an enzyme and travel along DNA strands that are stretched by predetermined configured beads (e.g., magnetic beads).

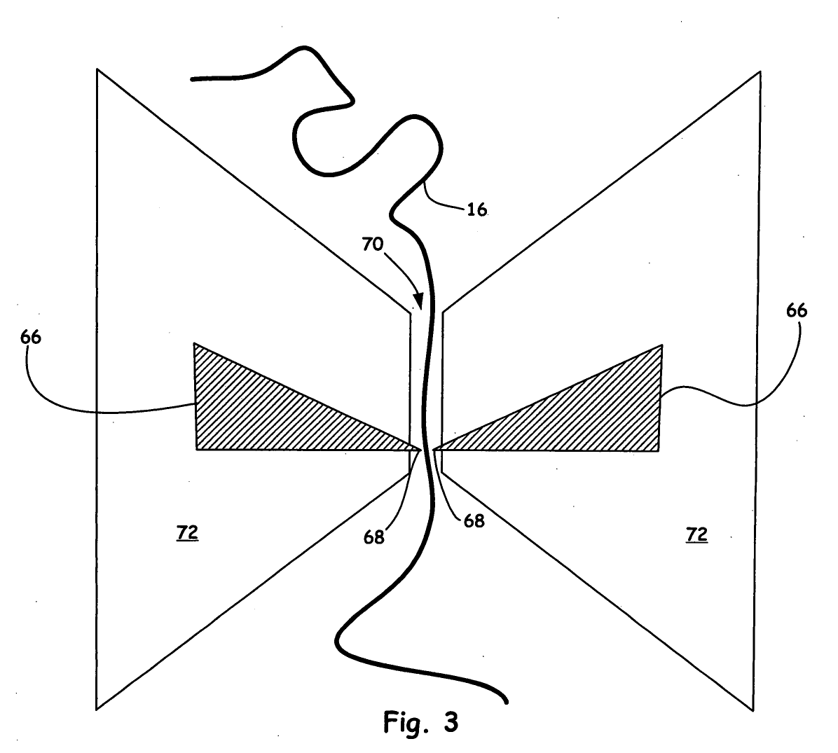

FIG. 3 illustrates a wedge resonant structure 66 of the present invention. Calculations have shown that wedge structures 66 of this type are capable of producing a localized electric field enhancement of 400 at the tips 68 of such wedges (Chem. Phys. Lett., 341, 1 (2001)). By engineering such wedge structures 66 into a flow channel 70 resulting from a microfluidic structure 72 with the channel 70 dimension width on the order of the width of the DNA strand (i.e., less than about 10 nm), and pulling the DNA through the channel using techniques discussed above, the SERS signal from a very predetermined segment of a DNA molecule can be obtained.

### Example Detection Apparatus

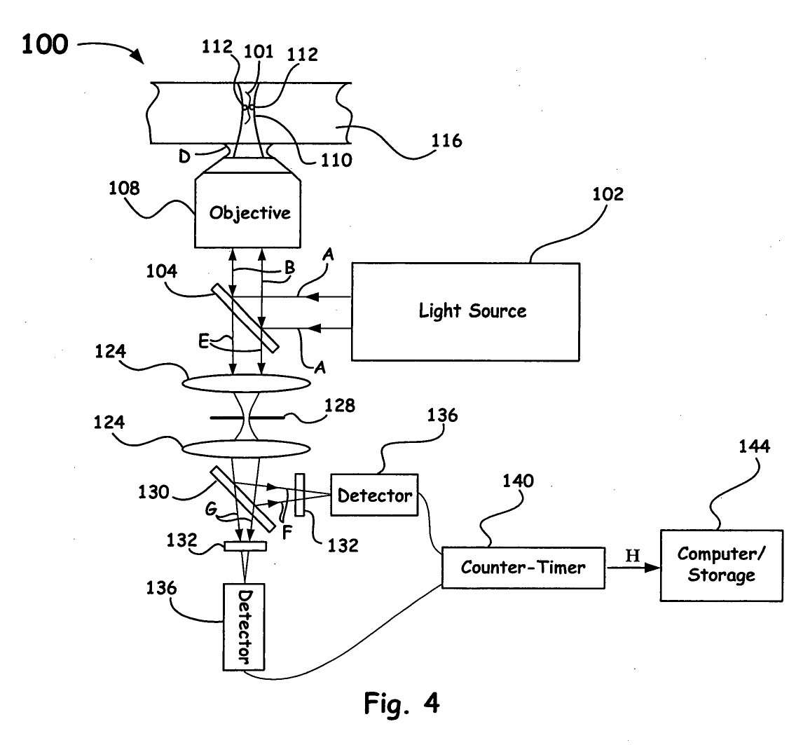

FIG. 4 illustrates an example detection apparatus, generally designated as reference numeral 100, for monitoring a predetermined Raman signal, e.g., SERS, and/or SEERS, and/or CARS, and/or SECARS, from individual nucleotides of a given molecule 101. Such an arrangement often can include electromagnetic radiation source 102, a mirror 104, such as a dichroic, an optical element 108, such as, but not limited to a microscope objective, resonant structures 112 capable of being configured about a channel, for example, within an aqueous solution 116, one or more optical elements 124 coupled with a pinhole 128, one or more beam directing elements 130, and one or more optical filters 132, such as edge filters, band-pass filters and/or notch filters to allow desired bands of electromagnetic radiation resulting from the induced Raman radiation to be monitored by detectors 136. Such monitored radiation can be directed to coupled electronics, such as, but not limited to, a counter-timer 140 when operating in a single photon counting mode and coupled electronically (denoted by H) to an analyzing means, e.g., a computer 144, such as, a desktop or a laptop computer having the required memory storage capacity for captured and detected data, and in-house designed or commercially available processing software for further processing and analysis of such data.

Electromagnetic radiation source 102 can include one or more gas (e.g., a 633 nm He—Ne laser) or solid-state lasers, e.g., Ti:Sapphire, Nd:YAG lasers, compact diode laser sources, etc., having either a continuous wave output or a pulsed output of up to about 80 MHz with such sources 102 configured with wavelengths of at least 200 nm, more often between about 200 nm and about 1100 nm, and capable of a peak energy of up to about 3×10⁻⁹ J. In the CARS detection mode, an exemplary arrangement for source 102 can include two Ti:Sapphire lasers tunable from 750-950 nm, running at up to about 80 MHz repetition rate, and electronically locked so that the pulses can be overlapped in time when operating. Whatever source 102 arrangement is designed into the apparatus of FIG. 4, the resultant output(s) can be directed along a path denoted by the letter A with accompanying arrows, as shown in FIG. 4, and onto a directing means (e.g., e-beam deposited beam-splitters, liquid crystal splitters, electro-optic devices, acousto-optic devices, mechanically driven reflective devices, and/or dichroic optics) such as, a mirror 104. Mirror 104, which is dependent on wavelength and reflectivity based upon a designed received incidence angle, often at 45°, then can direct the radiation received from beam path A along the beam path denoted by the letter B.

Additional directing means, such as optical element 108, arranged along beam path B, can be, for example, a diffractive optical component, such as a microscope objective operating in a confocal microscope configuration (e.g., operating with immersion oil as denoted by the letter D) to produce a beam spot 110 (e.g., a spot size defined within the Rayliegh range of element 108) having an intensity of often up to about 1 megawatt/cm². Such a desired intensity can be directed by optical element 108 to a designed area wherein resonant structures 112 and the arranged molecule(s) 101 of the present invention are illuminated upon crossing or upon positioning (e.g., by translation stages) into the region 110 that results into a beam spot having the desired intensity.

Resonant structures 112 having predetermined configurations, as discussed above, are designed to scatter radiation facilitated by the excitation of plasmon modes (e.g., in SERS) produced on the surface of the structures. Element 108 can additionally operate as a means to collect, for example, scattered surface enhanced plasmon radiation, and direct such Raman induced radiation along path B through mirror 104 and along a path denoted by the letter E. The present invention can have optical diffractive elements 124 coupled with a pinhole 128 for rejecting out-of-focus light/beam homogenization and/or beam shaping and a predetermined filter, such as a notch filter (not shown) can be used to remove the Rayleigh scattered light (i.e., the scattered photons having the same energy as the incident photons illuminating resonant structures 112). The remaining Raman scattered light can be directed by additional one or more beam-directing means 130, such as, dichroic optics, e-beam deposited beam-splitters, liquid crystal splitters, electro-optic devices, acousto-optic devices, and/or mechanically driven reflective devices. By utilizing such beam-directing means 130, the nucleic acid specific Raman mode can be directed along, for example, either beam paths F and G in FIG. 4, through designed filters 132, such as, for example, narrow band-pass filters, edge filters, acousto-optic filters, etc., to select the predetermined Raman modes of interest. The resulting radiation can then be focused onto one or more means 136 of detection that aid in the identification of desired Raman spectra. For example, the means can include avalanche photodiodes operating in a single photon counting mode, spectrometers, (note: spectrographs, spectrometers, and spectrum analyzers are used interchangeably), which can include optical spectrum analyzers, such as, two-dimensional spectrum analyzers, single or single curved line spectrum analyzers, monochrometers, CCD cameras (e.g., liquid nitrogen cooled CCD cameras, a back-illuminated, liquid nitrogen cooled CCD detector, two-dimensional array detectors, a multi-array detector, an on-chip amplification CCD camera, an avalanche CCD) photomultipliers etc., or any equivalent acquisition means of acquiring the spectral information needed so as to operate within the specifications of the present invention. Upon capture by means 136, further detection by, for example, a photon counter 140, can be utilized to enable SERS, SERRS, or CARS spectral data to be processed (e.g., mathematically manipulated), stored, further analyzed, compared, etc., by analysis means 144 for immediate or future processing and/or evaluation.

Apparatus 100, which can be beneficially automated, often includes a graphical user interface (GUI) configured from Visual Basic, MATLAB®, LabVIEW®, Visual C++, or any programmable language or specialized software programming environment to enable ease of operation when performing molecule analysis. LabVIEW® and/or MATLAB® in particular, is specifically tailored to the development of instrument control applications and facilitates rapid user interface creation and is particularly beneficial as an application to be utilized as a specialized software embodiment in the present invention.

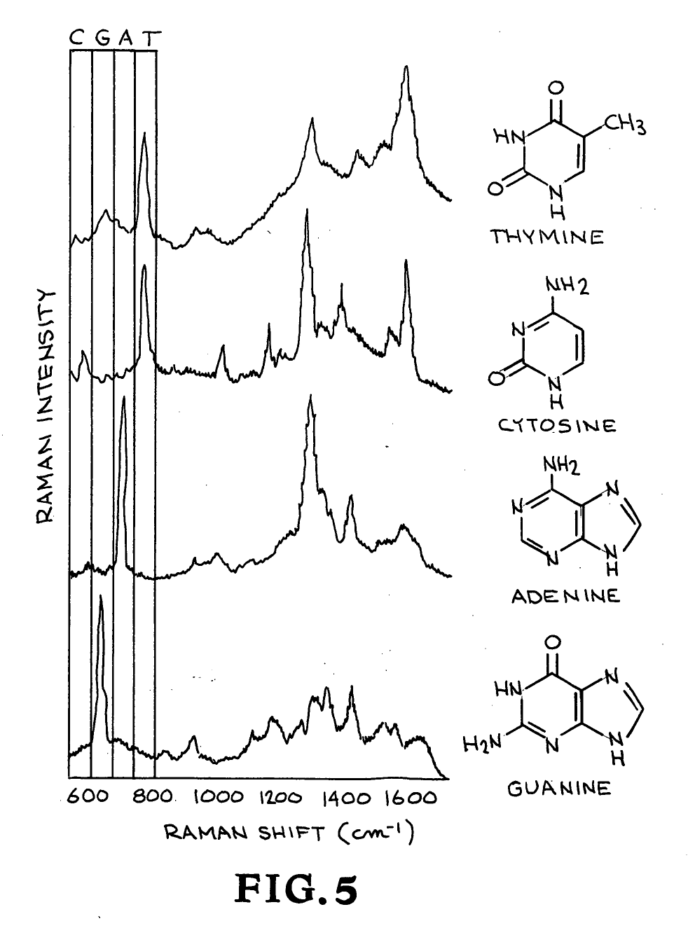

FIG. 5 shows example SERS spectra of the four nucleic acids (i.e., C, G, A, and T) detected with sufficient speed and high throughput using the example detection apparatus as shown in FIG. 4. The x-axis in these spectra gives the wavenumber in units of inverse centimeters which is related to the shift in photon wavelength due to Raman scattering. The y-axis gives the photon intensity in a small range (or bin) of wavenumbers. The intensity is related to the number of detector counts which in turn is related to the number of detected photons within each bin. Typically the spectrum is divided into 1000 to 2000 individual contiguous wavenumber bins. The ring-breathing modes of the nucleic acids in the range of 600 to 800 cm−1 are indicated by the boxes labeled C, G, A, and T. Such ring-breathing modes are unique to each nucleic acid to be identified.

Although the present invention has been disclosed in the context of certain preferred embodiments and examples, it will be understood by those skilled in the art that the present invention extends beyond the specifically disclosed embodiments to other alternative embodiments and/or uses of the invention and obvious modifications and equivalents thereof.

In addition, while a number of variations of the invention have been shown and described in detail, other modifications, which are within the scope of this invention, will be readily apparent to those of skill in the art based upon this disclosure. It is also contemplated that various combinations or subcombinations of the specific features and aspects of the embodiments may be made and still fall within the scope of the invention.

Accordingly, it should be understood that various features and aspects of the disclosed embodiments can be carried out with or substituted for one another in order to form varying modes of the disclosed invention. Thus, it is intended that the scope of the present invention herein disclosed should not be limited by the particular disclosed embodiments described above

The invention claimed is:

1. An apparatus, comprising:
a fluidic channel configured to receive one or more polymeric biomolecules;
one or more preconfigured resonant pole nano-structures disposed therein said fluidic channel;
means optically coupled with said preconfigured resonant pole nano-structures and adjacent said one or more desired polymeric biomolecules for identifying a Raman induced spectra.

2. The apparatus of claim 1, wherein said preconfigured resonant pole nano-structures comprises at least one of: a monopole, a dipole, a serial dipole, a plurality of dipole pairs, and a quadrapole.

3. The apparatus of claim 2, wherein said preconfigured resonant pole nano-structures comprises a super-position of a plurality of said resonant pole nano-structures.

4. The apparatus of claim 2, wherein said preconfigured resonant pole nano-structures comprise at least one shape selected from: spherical, rodlike, cubic, triangular, and ellipsoidal.

5. The apparatus of claim 2, wherein said preconfigured resonant pole nano-structures comprise at least one structure selected from: a nanoshell, a nanoshell having a hole, and a nanoshell with a magnetic interior.

6. The apparatus of claim 1, wherein said Raman induced spectra comprises at least one of: surface enhanced Raman scattering (SERS), surface enhanced resonance Raman scattering (SERRS), and surface enhanced coherent anti-Stokes Raman spectroscopy (SECARS).

7. The apparatus of claim 6, wherein said Raman induced spectra is induced from at least one optical source comprising a continuous wave (CW) and a solid-state laser.

8. The apparatus of claim 7, wherein said at least one optical source comprises a wavelength of at least 200 nm.

9. The apparatus of claim 7, wherein said at least one optical source comprises a degree of polarization selected from: linear, elliptical, circular or random polarization so that additional or redundant spectral information can be obtained from said one or more polymeric biomolecules.

10. The apparatus of claim 1, wherein said fluidic channel comprises one or more microfluidic channels having an opening from about 0.1 nm to about 5 nm to pass respective said one or more polymeric biomolecules.

11. The apparatus of claim 1, wherein said means comprises at least one detector selected from: a photodiode, a spectrometer, a monochrometer, a charge coupled device (CCD), and a photomultiplier.

12. The apparatus of claim 1, wherein said apparatus further comprises a computer configured with a processing software.

13. The apparatus of claim 1, wherein said one or more polymeric biomolecules are directed therethrough said fluidic channel via a directional fluid flow.

14. The apparatus of claim 1, wherein said one or more polymeric biomolecules are directed therethrough said fluidic channel via electrophoresis.

15. The apparatus of claim 1, wherein one end of said one or more polymeric biomolecules comprises a coupled dielectric bead, said dielectric bead immobilized by way of an optical trap.

16. The apparatus of claim 1, wherein one end of said one or more polymeric biomolecules comprises a coupled magnetic bead, said magnetic bead immobilized by way of an applied magnetic field.

17. The apparatus according to claims 15 or 16, wherein one or more nucleotides are removed from the unattached end of said one or more polymeric biomolecules by an exonuclease so that said one or more removed nucleotides can be identified via a respective said Raman induced spectra.

18. The apparatus of 1, wherein both ends of said one or more polymeric biomolecules comprises a dielectric coupled bead, wherein said dielectric coupled beads are manipulated by a dual-optical trap so that said one or more polymeric biomolecules can be immobilized and stretched.

19. The apparatus of 1, wherein both ends of said one or more polymeric biomolecules comprises a magnetic coupled bead, wherein said magnetic coupled beads are manipulated by a magnetic field so that said one or more polymeric biomolecules can be immobilized and stretched.

20. The apparatus according to claims 18 or 19, wherein said resonant pole nano-structure is adapted as a read-head and configured to scan along the length of said stretched one or more polymeric biomolecules to enable sequencing.

21. The apparatus of according to claims 18 or 19, wherein said read head is fixed and said stretched one or more polymeric biomolecules is directed along said read head to enable sequencing.

22. The apparatus of claim 1, wherein said resonant pole nano-structures are coupled to said one or more polymeric biomolecules by way of a polymerase which carries said resonant pole nano-structures along said one or more polymeric biomolecules to enable sequencing.

23. An apparatus, comprising:
a fluidic channel configured to receive one or more polymeric biomolecules;
one or more preconfigured wedged resonant nano-structures disposed therein said fluidic channel; and
means optically coupled with said wedged resonant structure and adjacent said one or more desired polymeric biomolecules for identifying a Raman induced spectra.

24. The apparatus of claim 23, wherein said Raman induced spectra comprises at least one of: surface enhanced Raman scattering (SERS), surface enhanced resonance Raman scattering (SERRS), and surface enhanced coherent anti-Stokes Raman spectroscopy (SECARS).

25. The apparatus of claim 23, wherein said Raman induced spectra is induced from at least one optical source comprising a continuous wave (CW) and a solid-state laser.

26. The apparatus of claim 25, wherein said at least one optical source comprises a wavelength of at least 200 nm.

27. The apparatus of claim 25, wherein said at least one optical source comprises a degree of polarization selected from: linear, elliptical, circular or random polarization so that additional or redundant spectral information can be obtained from said one or more polymeric biomolecules.

28. The apparatus of claim 23, wherein said fluidic channel comprises one or more microfluidic channels having an opening from about 0.1 nm to about 5 nm to pass respective said one or more polymeric biomolecules.

29. The apparatus of claim 23, wherein said one or more polymeric biomolecules are directed therethrough said fluidic channel via a directional fluid flow.

30. The apparatus of claim 23, wherein said one or more polymeric biomolecules are directed therethrough said fluidic channel via electrophoresis.

31. The apparatus of claim 23, wherein said means comprises at least one detector selected from: a photodiode, a spectrometer, a monochrometer, a charge coupled device (CCD), and a photomultiplier.

32. The apparatus of claim 23, wherein said apparatus further comprises a computer configured with a processing software.

33. A sequencing method, comprising:
directing one or more polymeric biomolecules therethrough a fluidic channel;
sequentially probing the nucleotides along said one or more polymeric biomolecules by way of preconfigured resonant pole nano-structures; and
optically identifying said probed nucleotides by way of Raman induced spectra.

34. The method of claim 33, wherein said preconfigured resonant pole nano-structures comprises at least one of: a monopole, a dipole, a serial dipole, a plurality of dipole pairs, and a quadrapole.

35. The method of claim 33, wherein said preconfigured resonant pole nano-structures comprise at least one shape selected from: spherical, rodlike, cubic, triangular, and ellipsoidal.

36. The method of claim 33, wherein said preconfigured resonant pole nano-structures comprise at least one structure selected from: a nanoshell, a nanoshell having a hole, and a nanoshell with a magnetic interior.

37. The method of claim 33, wherein said Raman induced spectra comprises at least one of: surface enhanced Raman scattering (SERS), surface enhanced resonance Raman scattering (SERRS), and surface enhanced coherent anti-Stokes Raman spectroscopy (SECARS).

38. The method of claim 33, wherein said one or more polymeric biomolecules comprise at least one molecule selected from: synthetic nucleotide analogs, proteins, chromosomal DNA, mitochondrial DNA, single-stranded DNA, double-stranded DNA, triple stranded DNA, ribosomal RNA, transfer RNA, heterogeneous nuclear RNA, and messenger RNA.

39. The method of claim 32, further comprising: directing said one or more molecules therethrough said fluidic channel via a directional fluid flow.

40. The method of claim 33, further comprising directing said one or more molecules therethrough said fluidic channel via electrophoresis.

41. The method of claim 33, further comprising: coupling one end of said one or more polymeric biomolecules to a dielectric bead, said dielectric bead immobilized by way of an optical trap.

42. The method of claim 33, further comprising: coupling one end of said one or more polymeric biomolecules to a magnetic bead, said magnetic bead immobilized by way of an applied magnetic field.

43. The method according to claims 41 or 42, further comprising: removing one or more nucleotides from the unattached end of said one or more polymeric molecules by an exonuclease so that said one or more removed nucleotides can be identified via a respective said Raman induced spectra.

44. The method of claim 33, further comprising: coupling both ends of said one or more polymeric molecules comprises to a dielectric bead, wherein said dielectric coupled beads are manipulated by a dual-optical trap so that said one or more polymeric molecules can be immobilized and stretched.

45. The method of claim 33, further comprising: coupling both ends of said one or more polymeric molecules comprises to a magnetic coupled bead, wherein said magnetic coupled beads are manipulated by a magnetic field so that said one or more polymeric molecules can be immobilized and stretched.

46. The method according to claims 44 or 45, further comprising:
adapting said resonant pole nano-structure as a read-head to scan along the length of said stretched one or more polymeric molecules to enable sequencing.

47. The method according to claims 44 or 45, further comprising: fixing said read head and directing said stretched one or more polymeric molecules along said read head to enable sequencing.

48. The method of claim 33, further comprising: coupling said resonant pole nano-structures to a polymerase which carries said resonant pole nano-structures along said one or more polymeric molecules to enable sequencing.

49. The method of claim 33, further comprising: adapting said fluidic channel with one or more microfluidic channels having respective openings from about 0.1 nm to about 5 nm to pass said one or more polymeric biomolecules.

50. A sequencing method, comprising:
directing one or more polymeric biomolecules therethrough a fluidic channel;
sequentially probing the nucleotides along said one or more polymeric biomolecules by way of one or more preconfigured wedged nano-structures; and
optically identifying said probed nucleotides by way of Raman induced spectra.

51. The method of claim 50, wherein said Raman induced spectra comprises at least one of: surface enhanced Raman scattering (SERS), surface enhanced resonance Raman scattering (SERRS), and surface enhanced coherent anti-Stokes Raman spectroscopy (SECARS).

52. The method of claim 50, wherein said one or more polymeric biomolecules comprise at least one molecule selected from: synthetic nucleotide analogs, proteins, chromosomal DNA, mitochondrial DNA, single-stranded DNA, double-stranded DNA, triple stranded DNA, ribosomal RNA, transfer RNA, heterogeneous nuclear RNA, and messenger RNA.

53. The method of claim 50, further comprising: directing said one or more molecules therethrough said fluidic channel via a directional fluid flow.

54. The method of claim 50, further comprising directing said one or more molecules therethrough said fluidic channel via electrophoresis.

55. The method of claim 50, further comprising: adapting said fluidic channel with one or more microfluidic channels having respective openings from about 0.1 nm to about 5 nm to pass said one or more polymeric biomolecules.

56. The method of claim 50, further comprising: coupling one end of said one or more polymeric biomolecules to a dielectric bead, said dielectric bead immobilized by way of an optical trap.

57. The method of claim 50, further comprising: coupling one end of said one or more polymeric biomolecules to a magnetic bead, said magnetic bead immobilized by way of an applied magnetic field.

58. The method according to claims 56 or 57, further comprising: removing one or more nucleotides from the unattached end of said one or more polymeric molecules by an exonuclease so that said one or more removed nucleotides can be directed therebetween said one or more resonant wedged structures so that they can be identified via a respective said Raman induced spectra.
